(19) United States
(12) Patent Application Publication
(10) Pub. No.: US 2023/0331422 A1
(43) Pub. Date: Oct. 19, 2023

(54) A CONTAINER

(71) Applicant: Conopco, Inc., d/b/a UNILEVER, Englewood Cliffs, NJ (US)

(72) Inventors: Girish MURALIDHARAN, Bangalore (IN); Gaurav PATHAK, Bangalore (IN); Rajeesh Kumar RAMACHANDRAN, Bangalore (IN)

(21) Appl. No.: 18/001,338

(22) PCT Filed: Jun. 24, 2021
(86) PCT No.: PCT/EP2021/067274

§ 371 Date: Dec. 9, 2022

(30) Foreign Application Priority Data
Jun. 29, 2020 (EP) 20182876.1

(51) Int. Cl. B65D 1/02; B65D 23/08; B65D 75/00

(52) U.S. Cl. CPC B65D 1/0207; B65D 23/0814; B65D 75/008; B65D 2575/58

(57) ABSTRACT

The present invention relates to a container comprising a film substrate, wherein the film substrate comprises graphene or derivative thereof and an adhesive. It further describes method for preparing the container comprising steps of preparing a suspension of graphene or derivative thereof in solvent, providing an adhesive layer, coating the adhesive layer with the suspension, and allowing the solvent to evaporate.

The present invention relates to a container for containing a cleaning composition. In particular, it relates to a container with improved barrier properties.

Despite the prior art there remains a need for a container with improved barrier properties.

Accordingly, and in a first aspect there is provided a container comprising a film substrate, wherein the film substrate comprises graphene or derivative thereof and an adhesive.

Often containers are used to protect its content from environmental factors such as, moisture, air and contaminants. Such factors affect the product appearance and efficacy. For example, moisture ingression into a container containing detergent powder would make the powder soggy, which is not preferred by consumers. Further, moisture ingression may change the relative ratio of ingredients making the product unstable. A container blocks transfer of moisture and air, thus, helps in sustaining the product performance during storage. Therefore, there is a need for a container with improved barrier property.

We have surprisingly found that a container comprising a film substrate which contains graphene or derivatives thereof and an adhesive shows reduced water vapour transmission into container, thus providing improved barrier property.

The combination of graphene or derivative thereof and adhesive in the film substrate provides improved water vapour transmission without impacting the physicality of the film substrate. It remains flexible and can be processed using conventional equipment in the normal manner. It also suffers from no obvious design constraints. Thus, the film substrate can be used to form containers of different size and shape based on the contents to be stored and applications.

According to the present invention there is provided a container. The container comprises a film substrate. The film substrate comprises graphene or derivative thereof and an adhesive.

Graphene is hydrophobic and can be obtained in two manners. The first is by peeling layers from graphite until you achieve a graphene monolayer. The second is known as Chemical Vapor Deposition (CVD) and where large-scale uniformity can be obtained and controlled.

Preferably the graphene derivative suitable for the invention is graphene oxide. Graphene oxide (GO) is hydrophilic and can be manufactured through Hummer's method. GO is also commercially available and may be procured from suppliers such as Platonic Nanotech.

Graphene oxide coating with a thickness of few tens of nanometres is impermeable. The graphene oxide coating can be applied directly or as a composite polymeric films coating containing graphene oxide and show good water retention behaviour.

The film substrate comprises an adhesive. Preferably, the adhesive is a pressure sensitive adhesive. Pressure sensitive adhesives are typically a class of adhesive activated by a pressure on it against a surface

The adhesive is preferably selected from materials that having a shear elastic modulus <0.3 MPa at a frequency of 1 Hz and more preferably 0.1 to 0.2 MPa.

The adhesives suitable for the invention include those based on natural rubber, synthetic rubber, styrene block copolymer, polyvinyl ether, acrylics, poly α-olefins, silicones, polyurethanes, and poly-urea based adhesives and combination thereof. The natural rubber-based adhesive may contain recycled or masticated natural rubber. Preferably the adhesive may further comprise additives such as tackifying resin, plasticizer, pigments etc.

The adhesive is preferably selected from acrylics, styrene block copolymers, silicon, natural rubber based adhesives and combination thereof. Preferably the adhesive is a natural rubber-based adhesive.

Graphene can be applied to the adhesive, or the adhesive applied to the graphene or graphene derivative as a film or in another form such as a powder. For example, graphene oxide powder can be pre-mixed with an appropriate polymer, for example polyvinyl alcohol, in advance of being applied as a pre-mix to an adhesive to form a layer.

A further mechanism for applying graphene or graphene derivative to a substrate is by way of soft lithography which involves transfer of material from one substrate to another via use of a silicone such as PDMS.

Preferably, the container comprises a plastic material. Preferably it is used to form the container. The plastic material provides the desired shape and structural support to the container. Preferably the film substrate is adhered to the plastic material on the surface of the container. The adhesive is preferably applied on to the surface of container and the graphene or derivative thereof is coated on the adhesive by spray or dip coating.

Preferably, the plastic material comprises polymers suitable for packaging application. The plastic material may comprise a single polymer or blend of two or more polymers. The polymers may be selected from polyesters, polyolefins, polyamides, polystyrene (PS), polyanhydrides, polyacrylates, poly hydroxy alkanoates, poly vinyl chloride, thermoplastic polyurethanes, polycarbonate (PC), polylactic acid (PLA), acrylonitrile/butadiene/styrene copolymer (ABS), styrene/acrylonitrile copolymer (SAN), polyoxymethylene (POM), biodegradable thermoplastics, starch-based thermoplastics, their derivatives, and combination thereof.

Preferably the polymer comprises a polyolefin containing olefin monomer in polymerized form. Examples of monomer include ethylene, propylene and optionally may comprise one or more co-monomers.

Polyolefins are typically produced from a simple olefin (also called an alkene with the general formula CnH2n) as a monomer. For example, polyethylene (PE) is the polyolefin produced by polymerizing the olefin ethylene (C2H4). Polypropylene (PP) is another common polyolefin which is made from the olefin propylene (C3H6). Copolymers of ethylene and propylene are also useful polymers in accordance with the present disclosure.

A preferred polyolefin according to the present invention is a polyethylene. This includes polyethylene homopolymers or copolymers. Common forms of polyethylene known in the art include Linear Low-Density Polyethylene (LLDPE), Low Density Polyethylene (LDPE), Ultra Low-Density Polyethylene (ULDPE), Very Low-Density Polyethylene (VLDPE), Medium Density Polyethylene (MDPE), and High Density Polyethylene (HDPE).

LLDPE is a linear ethylene/α-olefln copolymer containing heterogeneous short-chain branching distribution comprising units derived from ethylene and units derived from at least one C3 to C10 α-olefin comonomer. LLDPE has a density from 0.910 g/cc to less than 0.940 g/cc. Non-limiting examples of LLDPE indude TUFLIN™ linear low density polyethylene resins (available from The Dow Chemical Company), DOWLEX™ polyethylene resins (available from the Dow Chemical Company), FINGERPRINT™ polyethylene resins (available from Dow Chemical Company), DOWLEX™ 2038.68G, ELITE™, ELITE™ AT, and AFFINITY™, enhanced polyethylene, such as ELITE™ 5400G, available from the Dow Chemical Company, and MARLEX™ polyethylene (available from Chevron Phillips). The copolymers may comprise just one comonomer or terpolymers, i.e., copolymers of ethylene with two further comonomers, is particularly preferred. Said terpolymer is one specific preferred linear low-density polyethylene (LLDPE). The linear low-density polyethylene (LLDPE) contains preferably just one or two type(s) of C3 to C10 α-olefin comonomer(s). Still more preferably, the comonomer(s) is/are selected from the group consisting of 1-butene, 1-hexene, 1-octene and mixtures thereof. In one preferred embodiment the comonomer employed is 1-octene. In another preferred embodiment the linear low-density polyethylene (LLDPE) is a terpolymer consisting of ethylene, 1-butene and 1-hexene. Preferably the linear low-density polyethylene (LLDPE) has a melt flow rate MFR2 (190° C., 2.16 kg) in the range of 0.15 to 8.0 g/10 min, more preferably in the range of 0.15 to 4.0 g/10 min, more preferably in the range from 0.15 to 2 g/10 min, more preferably in the range of 0.3 to 1 g/10 min and still preferably in the range from 0.5 to 1 g/10 min.

One of the techniques to prepare LLDPE polymers, involves copolymerizing ethylene and butene 1 in the vapor phase in a fluidized bed process. By reason of the constraints imposed by carrying out the polymerization in the vapor phase, the ethylene polymers prepared by this process are limited to copolymers of ethylene and butene 1. By operating in solvent systems, copolymers can be prepared from alpha-mono olefin comonomers containing up to 12 carbon atoms. Preferably the linear low-density polyethylene are ethylene copolymers having polymerized therein at least one α-mono-olefin comonomer to containing 6 to 12 carbon atoms, and which optionally also will have copolymerized therein butene 1.

Low density polyethylene (LDPE) comprises ethylene homopolymer, or ethylene/α-olefin copolymer comprising at least one C3 to C10 α-olefin and has a density preferably from 0.915 g/cc to less than 0.940 g/cc. It contains long chain branching with broad molecular weight distribution. LDPE is typically produced by way of high pressure free radical polymerization (tubular reactor or autoclave with free radical initiator). Non-limiting examples of LDPE indude MarFIex™ (Chevron Phillips), LUPOLEN™ (LyondellBasell), as well as LDPE products from Borealis, INEOS, ExxonMobil, and others. Preferably the low-density polyethylene (LDPE) has a melt flow rate MFR2 (at 190° C., 2.16 kg) in the range of 0.05 to 2.0 g/10 min, more preferably in the range of 0.10 to 1.8 g/10 min, and more preferably in the range of 0.15 to 1.5 g/10 min. Accordingly, one example of such low-density polyethylene (LDPE) is the commercial product FT5230 of Borealis AG. Examples of other commercially available polyethylene that can be used in accordance with the present invention include those available from the Dow Chemical Company under the names DOW LDPE™ and AGILITY™.

HDPE is an ethylene homopolymer or an ethylene/α-olefin copolymer with at least one C4 to C10 α-olefin comonomer, or C4 to C8 α-olefin comonomer and a density from 0.0940 g/cc to 0.980 g/cc. Preferably the density is at least 0.0945 g/cc, still preferably at least 0.0950 g/cc, still further preferably at least 0.0953 g/cc, but preferably the density is not more than 0.975 g/cc, still preferably not more than 0.0970 g/cc, still further preferably not more than 0.0965 g/cc, further more preferably not more than 0.0960 g/cc and most preferably not more than 0.0955 g/cc.

HDPE can be a monomodal copolymer or a multimodal copolymer. A monomodal ethylene copolymer is an ethylene C4 to C10 α-olefin copolymer that has one distinct peak in a gel permeation chromatography (GPC) showing the molecular weight distribution. A multimodal ethylene copolymer is an ethylene C4 to C10 α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), CONTINUUM™ Bimodal Polyethylene Resins (available from The Dow Chemical Company), LUPOLEN™ (available from LyondellBasell), as well as HDPE products from Borealis, INEOS, and ExxonMobil. Preferably HDPE has a melt index of less than about 0.5 gm/10 min, preferably less than 0.4 grams/10 minutes, and will have polymerized therein at least about 98 mol % ethylene with any comonomer polymerized therein being an alpha-mono olefin containing about 3 to 12 carbon atoms.

HDPE polymers are typically prepared by polymerizing ethylene, optionally in the presence of an a mono olefin comonomer containing 4 to 12 carbon atoms in the presence of certain metallic catalysts such as chromium catalysts, e.g., CrO₃ supported on silica-alumina supports, and the Ziegler-Natta catalysts, e.g., TiCl₃ employed in conjunction with certain aluminum alkyl cocatalysts. The requisite density and melt index desired in the polymer are obtained by proper control of polymerization conditions including temperature, pressure comonomer concentration etc. HDPE is commercially available for example, RELENE F46003 is a high-density polyethylene (HDPE) having a density of 0.946 g/cc (ASTM D1505) and a melt index of 0.38 g/10 minutes (at 2.16 Kg load and a temperature of 190° C., ASTM D1238), from the Dow Chemical Company under the names DOW™ HDPE resins and DOWLEX™.

Polyamide may be used as suitable polymer material. Polyamide is be made of a homopolymer, or a copolymer. Useful polyamide homopolymers include nylon 6 (polycaprolactam), nylon 11 (polyundecanolactam), and nylon 12 (polylauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), and nylon 12,12 (polydodecamethylene dodecanediamide).

Another useful polyamide copolymer also includes nylon 6,6/6 copolymer (polyhexamethylene adipamide/caprolactam copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), nylon 6,6/6,9/6 copolymer (polyhexamethylene adipamide/hexamethylene azelaiamide/caprolactam copolymer), as well as other nylons which are not particularly delineated here. One of the examples of commercially available nylon is grade of Nylon is ULTRAMID™ B33L ex. BASF.

Polyethylene terephthalate (PET) is one of the polyesters, which can be used in the present invention. PET exists both as amorphous (transparent) and as semi-crystalline (opaque and white) polymer material. Semicrystalline PET has good strength, ductility, stiffness, and hardness. Amorphous PET has better ductility but less stiffness and hardness. Other examples of polyester material are polyethylene napthalate (PEN), poly butylene terephthalate, polycarbonate etc.

In another scenario, the plastic materials may be recycled polymers, which includes post-consumer recycled (PCR) or post-industrial recycled (PIR). The recycled polymers may be a mechanically recycled or a chemically recycled polymer.

Post-consumer recycled (PCR) refers to polymers that has reached the intended end user or consumer, is no longer being used for its intended purpose, and which has been collected or reclaimed after it is discarded by the end user or consumer. Thus, for example, it is understood that the term refers to material that would have otherwise been disposed of as waste but has instead been collected and recovered (reclaimed) as a material input, in lieu of new virgin material, for a recycling or manufacturing process. The term is inclusive of such collected or reclaimed materials which have been further treated or processed to facilitate re-use of the material. Preferably the recycled polymer is a mechanically recycled material. Example of commercially available recycled polyolefin are, from Corpela (Italian Consortium for the collection, recovery, recycling of packaging plastic wastes), Resource Plastics Corp. (Brampton, ON), Kruschit GmbH, Plastics and Recycling (AT), Vogt Plastik GmbH (DE), recycled LDPE from Ecoplast etc.

The container may comprise paper either in addition to the plastic or instead of the plastic. Paper herein refers to paper-based materials suitable for packaging application. Preferably the paper is used to form the container providing desired shape and structural support. Preferably the film substrate is adhered to the paper on the surface of the container. The adhesive is preferably applied to the surface of container and the graphene or derivative thereof is coated on the adhesive by spray or dip coating.

Paper is typically containing cellulose fibres and process from wood pulp. Papers are easily biodegradable, thus preferred over the materials obtained from non-renewable sources. Preferably the container comprises virgin paper or recycled paper or a blend of both. Virgin paper herein refers to a paper which has been first time using wood pulp, whereas recycled paper is the paper obtained after reprocessing of virgin paper, recycled wastepaper itself or their combinations. Preferably paper-based containers comprise polymer or hydrophobic coating for further enhancing the barrier property.

We have further found that the presence of graphene and or graphene oxide in paper can increase the recyclability of paper further by improving the number of times paper can be recycled before it becomes unmanageable.

The adhesive is preferably applied on to the surface of container by spray or dip coating.

Preferably, the container comprises 0.1 to 5 mg/cm² of the adhesive and more preferably 0.3 to 2 mg/cm². A suitable method for applying an adhesive to a surface of a container may found in EP 3 268 237 A1 (Unilever).

Further, biodegradable, natural rubber-based adhesives are commercially available directly on paper. One commercially available sample, TESA 4302 (High performance paper masking tape up to 160° C.) from TESA tapes is described herein.

Alternatively, the adhesives can be spray coated on the surface of the container to get a coverage of 1.5 mg/cm². The range of adhesive coating can be from 0.1 to 5 mg/cm². A commercially available example is Repositionable 75 spray Adhesive® (ex-3M).

The graphene or derivative thereof can be applied to the adhesive in a manner of ways. The process of transfer of graphene on copper substrate is known via multistep copper etching process and time consuming (An, Cheng Jin, et al. “Ultraclean transfer of CVD-grown graphene and its application to flexible organic photovoltaic cells.” Journal of Materials Chemistry A 2.48 (2014): 20474-20480; Van Ngoc, Huynh, et al. “PMMA-etching-free transfer of wafer-scale chemical vapor deposition two-dimensional atomic crystal by a water-soluble polyvinyl alcohol polymer method.” Scientific reports 6 (2016): 33096.)

Roll to roll process of graphene from copper substrate has been demonstrated in the literature (Bae, Sukang, et al. “Roll-to-roll production of 30-inch graphene films for transparent electrodes.” Nature nanotechnology 5.8 (2010): 574.)

Preferably, the CVD process is used to form a monolayer (or bilayer graphene) grown on copper substrate and transferred to the adhesive layer. This eliminates the need for copper etching.

The container is preferably a structure designed to contain a further unspecified material such as primary packaging for a liquid, solid, particulate or for a plurality of smaller items in need of secondary packaging. Primary or secondary packaging options may include packaging such as a box, a carton. In another scenario, it may include flexibles such as a doy pack, a sachet. In yet another scenario, the primary packaging option may be a unit dose capsule.

Preferably, the container is a substantially rigid container such as a bottle or box and provides structural support to maintain its own shape. Preferably the container is in the form of bottle, jar, jug etc. Preferably the container is provided with a cap. Preferably the container comprises polymer materials such as HDPE, polypropylene, polystyrene etc. Preferably the polymers constitute the body of the container. Preferably the adhesive is applied to outer surface of the of the container and subsequently graphene oxide dispersion is applied to the adhesive. In another embodiment, the film substrate is formed separately with the graphene oxide and the adhesive and subsequently glued to the outer surface of the container.

In one scenario, the rigid container may comprise corrugated packaging material or paper board. Preferably the container is formed in the shape of a box. Preferably the adhesive is applied to the surface of the box and graphene oxide dispersion is applied to the adhesive uniformly forming a film substrate. Preferably the film substrate resides outside surface of the box.

In another scenario, the container may be flexible container such as a bottle, which may be squeezed to eject the container's contents when desired. Preferably the container comprises flexible polymeric material.

In another scenario, the container is a flexible container such that sachet, pouch, bag, stand-up pouch, tubes, gusseted pouch and other flexible pouch known in the art. Preferably the flexible container comprises a film or laminate containing polymers material such as LLDPE, LDPE etc.

Preferably the film is a multilayer film. Preferably the adhesive is applied on to one the surfaces of the film and graphene oxide dispersion is applied to the adhesive uniformly.

Preferably the container is formed by sealing the film form sides. Preferably the container is re-fillable pouch with a sealable cap.

Preferably the container contents various consumer products such as detergent powder, detergent bar, laundry liquid detergent, fabric conditioner, dish washing liquid, hard surface cleaner, machine dish washing tablets in home care domain. In another scenario the container may content wide range of personal care products including skin cream, sunscreen, bathing bar, body lotions, shampoo, conditioner, tooth paste etc.

The graphene or derivative thereof may be applied to the inside or outside of the surface of the container such that the graphene derivative is either outermost or innermost of the container. Suitable containers include boxes for powders such as laundry detergent powders or other powders which are dissolved or dispersed in water before or during use. This is because these materials require shielding from excessive water during storage.

Other containers include flexible wraps for unit dosed products such as detergent tablets where water transfer is to be avoided where possible to maintain the integrity of the product in the wrapping and without the need for expensive secondary packaging.

In circumstances where the film is to be sealed it is preferably sealed on the surface away from the graphene or derivative.

The film substrate on the container can also be printed in the usual fashion either by printing on a base substrate on which is applied the adhesive and graphene or derivative or printing through the film with graphene pre-applied.

Printing is done typically using aqueous or organic based inks. Graphene is hydrophobic, hence organic based is preferred, while graphene oxide is hydrophilic. With the use of plasma treatment, one can tune the surface energy of graphene oxide and this can enable the inks to be printed with the right surface energy. Hence, we need to use organic inks. In any case one can print on the paper where present.

We have found that the graphene and graphene oxide do not absorb light significantly but do change colour depending on the thickness. For graphene, about less than 10 nm even considering 5 layers, while for graphene oxide, about 100 nm is appropriate. The transmission affects with increasing thickness or concentration.

In a second aspect there is provided a method for preparing a container according to the first aspect comprising steps of preparing a suspension of graphene or derivative thereof in solvent, providing a pressure sensitive adhesive layer, coating the adhesive layer with the suspension, and allowing the solvent to evaporate.

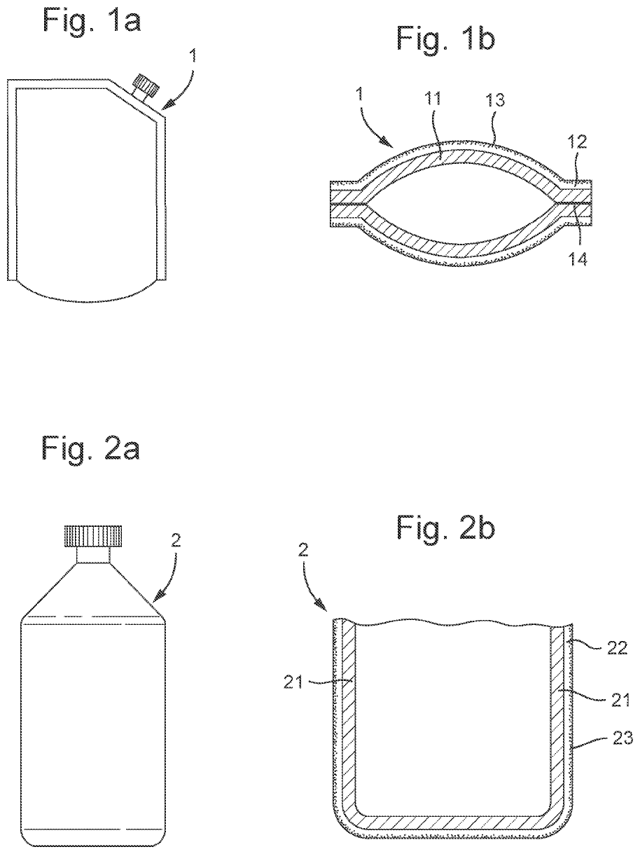

Embodiments of the invention are now described with reference to the following non-limiting examples in which FIG. 1 illustrates a stand-up pouch and FIG. 2 illustrates a bottle.

FIG. 1a provides an overview of a stand-up pouch (1) and FIG. 1b provides cross-section of the pouch. The pouch has a polymer layer (11) as inner most layer. An adhesive layer (12) is adhered to the polymer layer (11). Graphene oxide particles are applied on to the adhesive layer (12). The pouch is formed by sealing the polymer layers (11) at the sides (14).

FIG. 2a illustrates the invention with an example of a bottle. FIG. 2b provides cross-section the bottle. The bottle (2) has polymer layer (21). An adhesive (22) is provided on the outer surface of the polymer layer (21). Graphene oxide particles (23) are applied on to the adhesive layer (22). Thickness of the layers on both figures are not up to the scale and figures are only for illustration purposes. Figures do not limit the scope of the invention.

Embodiments of the invention are further described with reference to the following non-limiting examples.

### EXAMPLES

### Example 1

To evaluate the performance of the container, a detergent tablet was prepared according to below recipe:

| Ingredients | Wt. % |
|---|---|
| Surfactants (Mixture of LAS, SLES, MES) | 13.86 |
| Sodium carbonate | 26.96 |
| Sodium sulphate | 28.00 |
| Other fillers (Salt, clays) | 16.00 |
| Disintegrant | 12.00 |
| Moisture/minors | 3.18 |
| TOTAL | 100 |

The ingredients were dry mixed and compressed to form a tablet by applying direct compression.

At first, a film substrate comprising graphene oxide was prepared, by dispersing 50 mg of graphene oxide (ex. Platonic Nano Tech) in 15 mL water. The dispersion was spray coated on 14 cm xl 0 cm area PSA paper (TESA 4302) and dried at 50° C. for 3 hrs.

A container according to the present invention was formed by taking a tablet prepared by aforesaid process and wrapped it with the film substrate. Comparative container was formed by wrapping a tablet with a paper without graphene oxide and pressure sensitive adhesive.

To evaluate the efficacy, containers with tablets are stored in hot and humid (37° C., 85% humidity) condition. A tablet without any wrap was also stored along with the containers as control. Tablets were taken out from the container after regular interval and moisture contents of the tablets were evaluated.

| | Initial | | |
|---|---|---|---|
| | Moisture | After | |
| Tablet | content | 2 days | After 7 days |
| Detergent control Tablet | 7 | — | Didn't sustain as the |
| | | | entire tablet failed |
| Detergent tablet in | 7 | 18 | Didn't sustain as the |
| pure paper without | | | entire tablet failed |
| graphene oxide | | | |
| Detergent tablet in paper, | 7 | — | 11 |
| PSA, graphene oxide | | | |

With paper and PSA but no graphene oxide was not performed as the material is too sticky for commercial applications.

### Example 2

To evaluate the barrier property of the container, a container with a film substrate was prepared with graphene oxide and polyvinyl alcohol, pressure sensitive adhesive and paper.

PVA with graphene oxide suspension was prepared according to below recipe

| Ingredients | (g) | (%) |
|---|---|---|
| PVA (98% hydrolyzed) Mw 31-50 kDa | 0.3 | |
| PVA (88% hydrolyzed) Mw 85-124 kDa | 1.2 | |
| Total PVA | 1.5 | 90.5 |
| Plasticizer (PEG-200) | 0.15 | 9.05 |
| Graphene oxide (5 ml of 0.167%) | 0.0083 | 0.5 |
| Total | 1.675 | 100 |

1.5 g of PVA (mixture of two molecular weights) is added to 15 mL water to make an aqueous solution. The mixture was heated to 80° C., with stirring at 300 rpm until homogeneous solution is achieved.

To the above mixture, 0.15 g plasticizer (PEG-Mw 200) was added, mixed for 5 mins, and cooled down to room temperature.

5 mL of the 0.167% Graphene Oxide (GO) dispersion was added to the polymer resin after cooling, and mixing is continued.

10 mL of the suspension was casted on the TESA 4302 paper (contained in a tray) and dried at 50° C. for 3 hours. The dimension of the paper was 14 cm×10 cm.

The container was transparent unlike the previous case. PVA is one example but not limited by the polymer. The requirement for the polymer is it must intercalate with GO and form stable suspension and film should form upon drying. All polymers which are used for solvent-casting route is applicable for this.

Barrier properties of the container with the film were evaluated in terms of Water Vapour Transmission Rate (WVTR)

| Film Composition | WVTR (g/day · m²) |
|---|---|
| PVA (control) | 84.4 |
| PVA + GO (0.03%) | 32.0 |

The container comprising a film with graphene oxide shows improved WVTR, which implies better barrier properties.

1. A container comprising a film substrate, wherein the film substrate comprises graphene or derivative thereof and a pressure sensitive adhesive.

2. A container according to claim 1 wherein the pressure sensitive adhesive is a natural rubber-based adhesive.

3. A container according to claim 1 wherein the container comprises paper.

4. A container according to claim 1 wherein the container comprises a plastic material.

5. A container according to claim 1 wherein the graphene derivative is graphene oxide.

6. A container according to claim 1 wherein the container is a substantially rigid container.

7. A container according to claim 1 wherein the container is a flexible pouch.

8. A container according to claim 7 wherein the container is a unit dose capsule.

9. A method for preparing a container comprising a film substrate, the method comprising the steps of preparing a suspension of graphene or derivative thereof in a solvent, providing an adhesive layer to the outer surface of the container, coating the adhesive layer with the suspension, and allowing the solvent to evaporate thereby providing the film substrate residing on the outer surface of the container.
